(19) United States
(12) Patent Application Publication
(10) Pub. No.: US 2026/0015107 A1
(43) Pub. Date: Jan. 15, 2026

(54) Vibration absorption module and unmanned vehicle

(71) Applicant: Coretronic Intelligent Robotics Corporation, Hsin-Chu (TW)

(72) Inventors: CHIA-HAO CHANG, Hsin-Chu (TW); MIN-HSIU WU, Hsin-Chu (TW); HSU-CHIH CHENG, Hsin-Chu (TW); YING-CHIEH CHEN, Hsin-Chu (TW)

(21) Appl. No.: 18/926,366

(22) Filed: Oct. 25, 2024

(30) Foreign Application Priority Data
Jul. 11, 2024 (TW) 113207454

(51) Int. Cl. B64U 20/80

(52) U.S. Cl. CPC B64U 20/80

(57) ABSTRACT

A vibration absorption module and an unmanned vehicle using the vibration absorption module include following features. A base has a bottom plate portion and side wall portions connected to each other. A cover is connected to the side wall portions and opposite to the bottom plate portion. A central portion of a vibration absorption assembly between the base and the cover is fixed to a surface of the bottom plate portion facing the cover. A surround portion of the vibration absorption assembly is around the central portion and has a first pressed surface facing the cover and inclined relative to the surface. A data sensing assembly is between the vibration absorption assembly and the cover and contacts the central portion and the first pressed surface. A buffer member compressed between the cover and the data sensing assembly pushes the data sensing assembly against the central portion and the first pressed surface.

### CROSS-REFERENCE TO RELATED APPLICATION

This application claims the priority benefit of Taiwan application (No. 113207454), filed on Jul. 11, 2024. The entirety of the above-mentioned patent application is hereby incorporated by reference herein and made a part of this specification.

### TECHNICAL FIELD

The disclosure relates to a module, and more particularly to a vibration absorption module and an unmanned vehicle having the vibration absorption module.

### BACKGROUND

An unmanned vehicle broadly refers to a vehicle being able to move or fly without a driver or a pilot. For example, a flight path of an unmanned aerial vehicle can be controlled remotely or automatically without a pilot on board. Hence, a size of the unmanned aerial vehicle can be effectively reduced by omitting a cockpit to facilitate the performance of tasks such as reconnaissance and site exploration.

Generally, kinds of sensors are disposed and integrated on a printed circuit board of the unmanned vehicle, but a lot of vibrations are generated by the unmanned vehicle during moving or flying, causing the data recorded by the sensors to be seriously interfered by the vibrations. For example, most of the unmanned aerial vehicles are configured with a gyroscope to calculate flight attitude and output power by propellers, but lots of vibrations are continuously generated by the operation of the propeller, causing the data recorded by the gyroscope to contain a large amount of noise. Additionally, the vibrations generated by the unmanned vehicle during moving or flying often lack directionality, but a conventional vibration absorption module is only able to absorb vibrations in a single direction.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY

The disclosure provides a vibration absorption module to reduce vibrations to a data sensing assembly in the horizontal and vertical directions.

The disclosure provides an unmanned vehicle to reduce interference caused by vibrations on the data sensing assembly.

Other advantages and objects of the disclosure may be further illustrated by the technical features broadly embodied and described as follows.

In order to achieve one or a portion of or all of the objects or other objects, an embodiment of the disclosure provides a vibration absorption module including a shell assembly, a vibration absorption assembly, a data sensing assembly and a buffer member. The shell assembly includes a base body and a cover body, and the base body has a bottom plate portion and a plurality of side wall portions. The side wall portions are connected to the bottom plate portion, and the cover body is connected to the side wall portions and opposite to the bottom plate portion. The vibration absorption assembly is disposed between the base body and the cover body and includes a central portion and a surround portion. The central portion is fixed to a surface of the bottom plate portion facing the shell assembly. The surround portion is disposed around the central portion and has a first pressed surface facing the cover body. The first pressed surface is inclined with respect to the surface. The data sensing assembly is disposed between the vibration absorption assembly and the cover body and is in contact with the central portion and the first pressed surface. The buffer member is compressed between the cover body and the data sensing assembly and is adapted to push the data sensing assembly against the central portion and the first pressed surface.

In order to achieve one or a portion of or all of the objects or other objects, an embodiment of the disclosure provides an unmanned vehicle including a vehicle body and the vibration absorption module. The vibration absorption module is disposed at the vehicle body.

For the vibration absorption module of the disclosure, the vibration absorption assembly uses the central portion and the surround portion, wherein the central portion is able to reduce vibrations to the data sensing assembly in a vertical direction, and the surround portion is able to reduce vibrations to the data sensing assembly in a horizontal direction and the vertical direction by the first pressed surface inclined with respect to the surface. Also, the buffer member of the vibration absorption module is able to reduce vibrations to the data sensing assembly in the vertical direction. Hence, the vibration absorption module of the disclosure can effectively reduce the vibrations to the data sensing assembly in the horizontal direction and the vertical direction. The unmanned vehicle of the disclosure uses the vibration absorption module, so the unmanned vehicle is able to effectively reduce the interference caused by the vibrations on the data sensing assembly.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic explosion diagram of a vibration absorption module in a first embodiment of the disclosure;

FIG. 2 is a schematic cross-sectional diagram of the vibration absorption module in FIG. 1;

FIG. 3 is a schematic explosion diagram of a vibration absorption module in a second embodiment of the disclosure;

FIG. 4 is a schematic cross-sectional diagram of the vibration absorption module in FIG. 3;

FIG. 5 is a schematic top view of the counterweight element in FIG. 3;

FIG. 6 is a schematic explosion diagram of a vibration absorption module in a third embodiment of the disclosure;

FIG. 7 is a schematic cross-sectional diagram of the vibration absorption module in FIG. 6;

FIG. 8 is a schematic cross-sectional diagram of a vibration absorption module of a fourth embodiment of the disclosure;

FIG. 9 is a schematic explosion diagram of a vibration absorption module of a fifth embodiment of the disclosure;

FIG. 10 is a schematic cross-sectional diagram of the vibration absorption assembly in FIG. 9;

FIG. 11 is a schematic explosion diagram of a vibration absorption module of a sixth embodiment of the disclosure;

FIG. 12 is a schematic cross-sectional diagram of the vibration absorption assembly in FIG. 11;

FIG. 13 is a schematic diagram of an unmanned vehicle of an embodiment of the disclosure; and

FIG. 14 is a schematic diagram of an unmanned vehicle of another embodiment of the disclosure.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

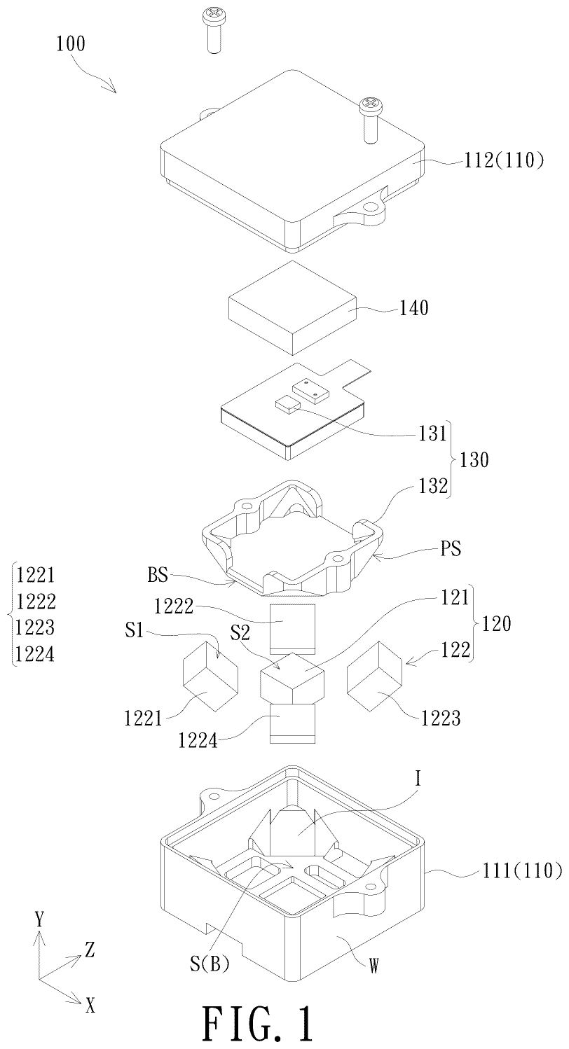

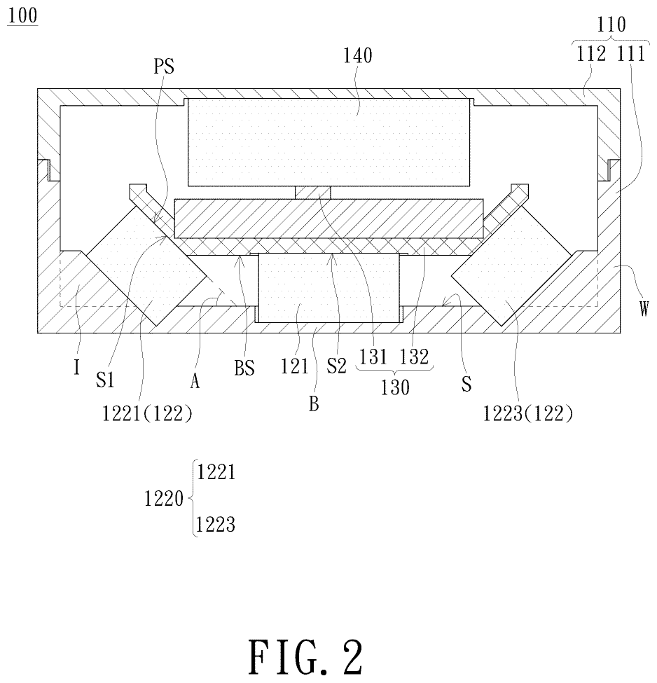

FIG. 1 is a schematic explosion diagram of a vibration absorption module in a first embodiment of the disclosure. FIG. 2 is a schematic cross-sectional diagram of the vibration absorption module in FIG. 1. Referring to FIGS. 1 and 2, a vibration absorption module 100 includes a shell assembly 110, a vibration absorption assembly 120, a data sensing assembly 130, and a buffer member 140. The shell assembly 110 includes a base body 111 and a cover body 112, and the base body 111 has a bottom plate portion B and a plurality of side wall portions W. The side wall portions W are connected to the bottom plate portion B, and the cover body 112 is connected to the side wall portions W and opposite to the bottom plate portion B. The vibration absorption assembly 120 is disposed between the base body 111 and the cover body 112 and includes a central portion 121 and a surround portion 122. The central portion 121 is fixed to a surface S of the bottom plate portion B facing the cover body 112. The surround portion 122 is disposed around the central portion 121 and has a first pressed surface S1 facing the cover body 112. The first pressed surface S1 is inclined with respect to the surface S. The data sensing assembly 130 is disposed between the vibration absorption assembly 120 and the cover body 112 and is in contact with the central portion 121 and the first pressed surface S1. The buffer member 140 is compressed between the cover body 112 and the data sensing assembly 130 and is adapted to push the data sensing assembly 130 against the central portion 121 and the first pressed surface S1.

A material of the vibration absorption assembly 120 may include foam, but the disclosure is not limited thereto. The central portion 121 can be substantially fixed to a center of the surface S, and the surround portion 122 can be fixed to a corner or an edge of the surface S to surround the central portion 121 in this embodiment. The central portion 121 is able to reduce the vibrations to the data sensing assembly 130 in a vertical direction, wherein the vertical direction is the direction Y. Additionally, the surround portion 122 is able to reduce the vibrations to the data sensing assembly 130 in the vertical direction and a horizontal direction, wherein the horizontal direction can be any direction parallel to the XZ plane. For example, an included angle A (marked in FIG. 2) between the first pressed surface S1 of the surround portion 122 and the surface S is between 40 degrees and 55 degrees, so that the effects of absorbing the vibrations in the vertical direction and the horizontal direction are more consistent. The included angle A may be about 45 degrees in one embodiment, but the disclosure is not limited thereto. Incidentally, the bottom plate portion B in this embodiment may be formed with an inclined base I on the corner of the surface S, and the surround portion 122 can be fixed to the inclined base I to make the first pressed surface S1 be inclined with respect to the surface S through the inclined base I.

On the other hand, the surround portion 122 may include a plurality of vibration absorption members 1220. The vibration absorption members 1220 are separated from each other and respectively separated from the central portion 121. Therefore, each of the vibration absorption members 1220 and the central portion 121 are able to independently reduce the vibrations to the data sensing assembly 130, thereby improving the vibrations absorbing effect of the vibration absorption assembly 120 to the data sensing assembly 130. Furthermore, the vibration absorption members 1220 can be fixed to the bottom plate portion B and may include a first vibration absorption member 1221, a second vibration absorption member 1222, a third vibration absorption member 1223, and a fourth vibration absorption member 1224. The first vibration absorption member 1221, the second vibration absorption member 1222, the third vibration absorption member 1223, and the fourth vibration absorption member 1224 are separated from each other and respectively separated from the central portion 121. The first vibration absorption member 1221 and the second vibration absorption member 1222 are respectively disposed on two opposite sides of the central portion 121, and the third vibration absorption member 1223 and the fourth vibration absorption member 1224 are respectively disposed on another two opposite sides of the central portion 121. For example, the bottom plate portion B may be in a quadrilateral manner, the first vibration absorption member 1221 and the third vibration absorption member 1223 may be respectively disposed on two opposite sides or corners of the central portion 121 along one of diagonal lines of the bottom plate portion B, and the second vibration absorption member 1222 and the fourth vibration absorption member 1224 may be respectively disposed on another two opposite sides or corners of the central portion 121 along another one of the diagonal lines of the bottom plate portion B. Similarly, the first vibration absorption member 1221, the second vibration absorption member 1222, the third vibration absorption member 1223, and the fourth vibration absorption member 1224 can be respectively fixed to the four inclined bases I to surround the central portion 121. Incidentally, the first vibration absorption member 1221, the second vibration absorption member 1222, the third vibration absorption member 1223, and the fourth vibration absorption member 1224 may be respectively equidistant from the central portion 121 in an embodiment. The number of vibration absorption members 1220 may include two, three, or more than four in another embodiment, which is not limited by the disclosure.

The data sensing assembly 130 in this embodiment can be pressed against the central portion 121 and the first pressed surface S1 of the surround portion 122. Specifically, the data sensing assembly 130 can include a sensing element 131 and a support element 132. The sensing element 131 is carried by the support element 132, and the support element 132 is in contact with the vibration absorption assembly 120 to reduce the vibrations transmitted to the support element 132 through the vibration absorption assembly 120. Furthermore, the support element 132 can be pressed against the central portion 121 and the first pressed surface S1 of the surround portion 122. Also, the shape of the support element 132 may be designed according to a shape of the vibration absorption assembly 120. For example, the support element 132 is disposed on the vibration absorption assembly 120 and has a bottom surface BS and a positioning surface PS. The bottom surface BS faces the central portion 121. The positioning surface PS is around the bottom surface BS and inclined with respect to the bottom surface BS. The bottom surface BS is in contact with the central portion 121, and the positioning surface PS is in contact with the surround portion 122. Particularly, the central portion 121 can have a second pressed surface S2, the bottom surface BS may be substantially parallel to the second pressed surface S2, and the positioning surface PS may be substantially parallel to the first pressed surface S1. Therefore, the support element 132 is able to more evenly contact the central portion 121 and the surround portion 122 through the bottom surface BS and the positioning surface PS, thereby further improving the effect of absorbing vibrations of the vibration absorption module 100. Incidentally, the bottom surface BS may have a slot corresponding to the central portion 121. The sensing element 131 includes, for example, an inertial measurement unit (IMU), but the disclosure is not limited thereto. It is worth mentioning that a weight of the support element 132 may be greater than a weight of the sensing element 131 in an embodiment; hence, the data sensing assembly 130 is able to more accurately push against the vibration absorption assembly 120 through the support element 132, thereby further improving the vibrations absorbing effect of the vibration absorption assembly 120 on the data sensing assembly 130.

The buffer member 140 can be compressed between the cover body 112 and the data sensing assembly 130 to absorb the vibrations to the data sensing assembly 130 in the direction Y in this embodiment. A material of the buffer member 140 may include foam. For example, the buffer member 140 in this embodiment may be cut and shaped from a whole piece of foam. The buffer member 140 may fill the space between the cover body 112 and the data sensing assembly 130 by filling with materials of the buffer member 140 in an embodiment. However, the materials and manufacturing processes of the buffer member 140 are not limited by the disclosure.

The base body 111 and the cover body 112 of the shell assembly 110 may be fixed to each other with screws (not labeled) in this embodiment. Additionally, the shell assembly 110 may have a waterproof or a dustproof function in one embodiment. A material of the shell assembly 110 in this embodiment may include polycarbonate (PC), but the disclosure is not limited thereto.

In the vibration absorption module 100 in this embodiment, the vibration absorption assembly 120 uses the central portion 121 and the surround portion 122, wherein the central portion 121 is able to reduce the vibrations to the data sensing assembly 130 in the vertical direction (direction Y), and the surround portion 122 reduces the vibrations to the data sensing assembly 130 in the horizontal direction (the direction parallel to the XZ plane) and the vertical direction by the first pressed surface S1 inclined with respect to the surface S. Also the buffer member 140 of the vibration absorption module 100 is able to reduce the vibrations to the data sensing assembly 130 in the vertical direction. Hence, the vibration absorption module 100 in this embodiment is able to effectively reduce the vibrations to the data sensing assembly 130 in the horizontal direction and the vertical direction, compared with the prior art.

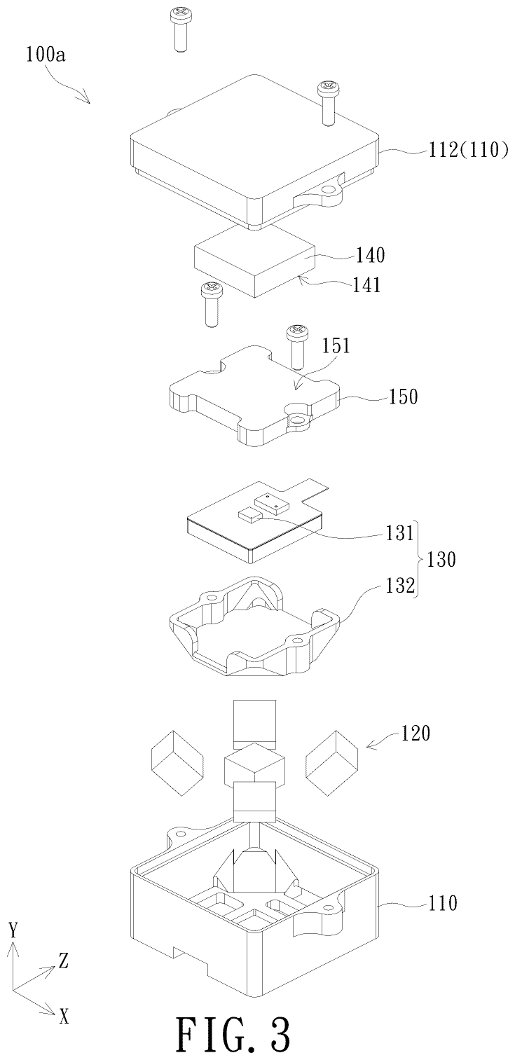

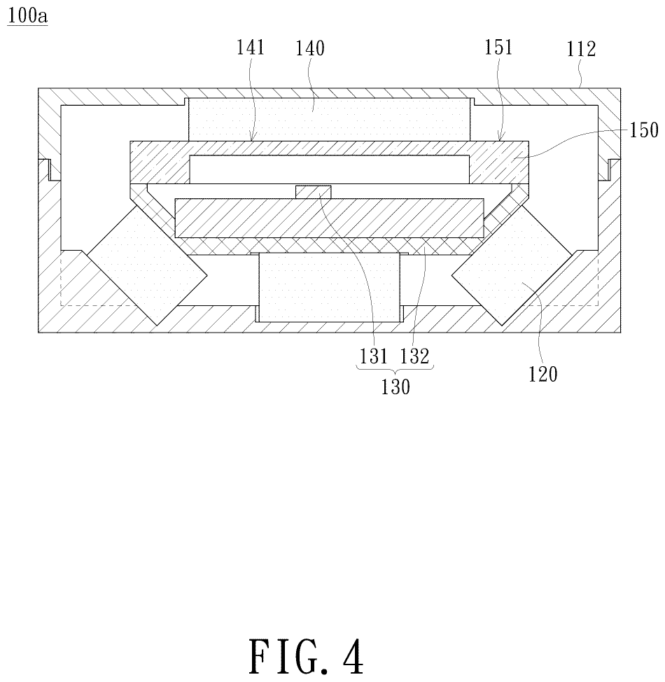

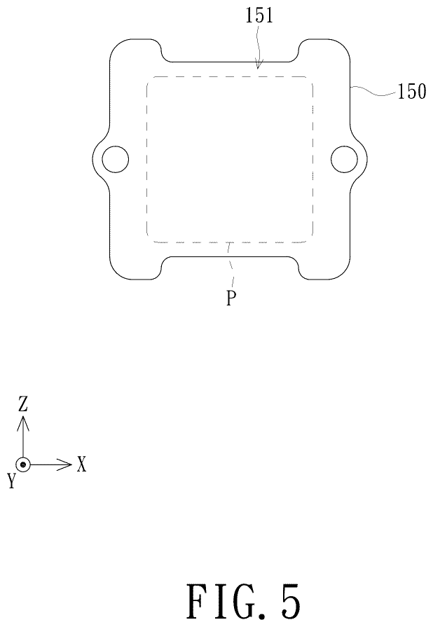

FIG. 3 is a schematic explosion diagram of a vibration absorption module in a second embodiment of the disclosure. FIG. 4 is a schematic cross-sectional diagram of the vibration absorption module in FIG. 3. FIG. 5 is a schematic top view of the counterweight element in FIG. 3. The structure and advantages of the vibration absorption module 100a in this embodiment are similar to those in the embodiment in FIG. 1, and only the differences are described below. Referring to FIG. 3 and FIG. 4 first, the vibration absorption module 100a can further include a counterweight element 150, and the counterweight element 150 is disposed between the buffer member 140 and the data sensing assembly 130. Hence, the data sensing assembly 130 can be more tightly against the vibration absorption assembly 120 through the pressure of the counterweight element 150, thereby improving the vibration absorbing effect of the vibration absorption assembly 120 to the data sensing assembly 130. Furthermore, a weight of the counterweight element 150 can be greater than a weight of the sensing element 131, and therefore, the counterweight element 150 can more accurately press against the data sensing assembly 130 to be more tightly against the vibration absorption assembly 120, thereby further improving the vibrations absorbing effect of the vibration absorption assembly 120 to the data sensing assembly 130. A material of the counterweight element 150 includes, for example, stainless steel, but other embodiments are not limited thereto. Similarly, a weight of the support element 132 can be greater than a weight of the sensing element 131 in this embodiment, so that the data sensing assembly 130 can more accurately press against the vibration absorption assembly 120.

Referring to FIGS. 4 and 5, the buffer member 140 is compressed between the cover body 112 and an outer surface 151 of the counterweight element 150 (also labeled in FIG. 3). An orthographic projection P of the buffer member 140 on the outer surface 151 of the counterweight element 150 has a first area, and the outer surface 151 has a second area. The first area is, for example, less than or equal to the second area, and this embodiment takes the first area being less than the second area as an example. Therefore, it is ensured that the buffer member 140 is completely in contact with the outer surface 151 of the counterweight element 150, so that the buffer member 140 can further reduce the vibrations to the counterweight element 150 and the data sensing assembly 130 in the direction Y, thereby further improving the effect of absorbing the vibrations to the data sensing assembly 130. Incidentally, the buffer member 140 may have a bottom surface 141 facing and contacting the counterweight element 150 (also marked in FIG. 3), and the first area of the orthographic projection P may be substantially equal to an area of the bottom surface 141 of the buffer member 140.

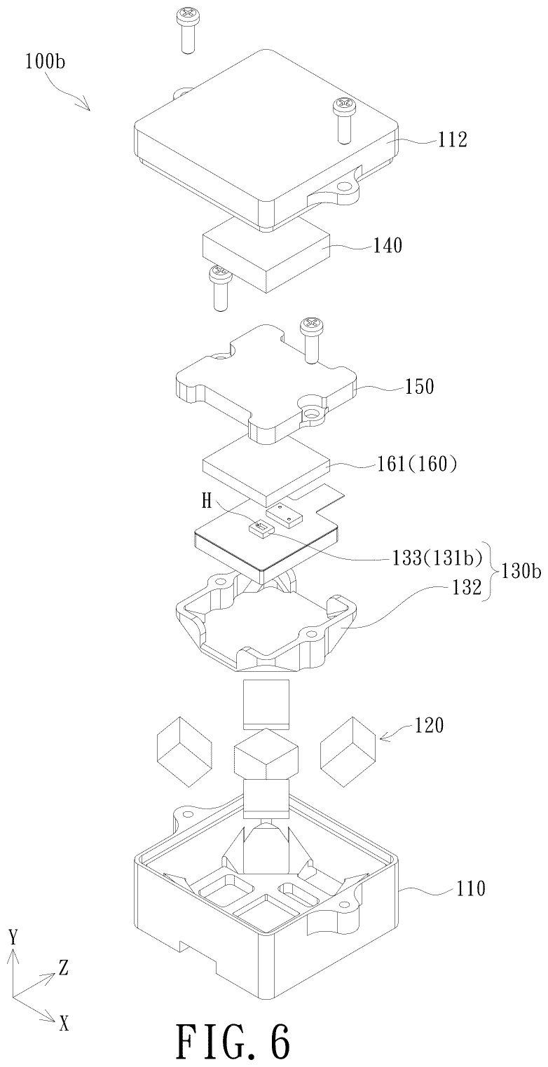

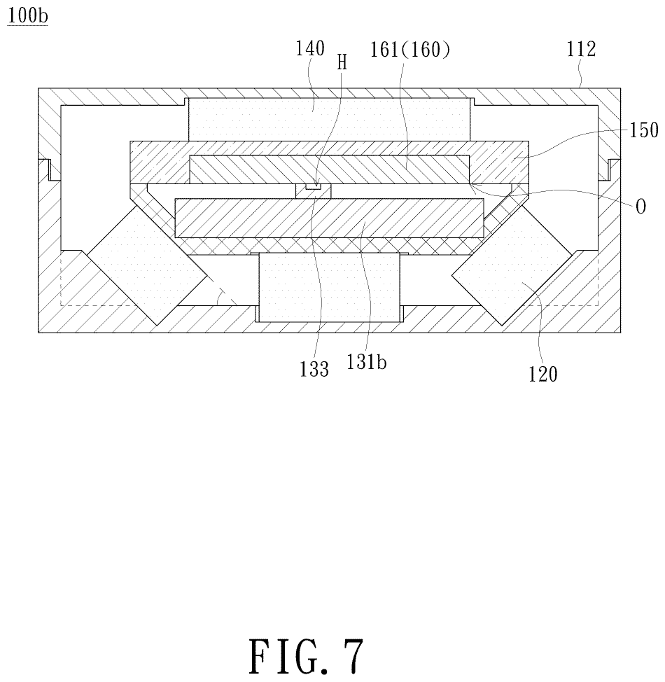

FIG. 6 is a schematic explosion diagram of a vibration absorption module in a third embodiment of the disclosure. FIG. 7 is a schematic cross-sectional diagram of the vibration absorption module in FIG. 6. The structure and advantages of the vibration absorption module 100b in this embodiment are similar to those in the embodiment in FIG. 3, and only the differences are described below. Referring to FIGS. 6 and 7, the vibration absorption module 100b can further include an air pressure buffer member 160. The data sensing assembly 130b includes an air pressure sensing member 133, and a side of the air pressure sensing member 133 facing the cover body 112 has a vent H. The air pressure buffer member 160 is located between the counterweight element 150 and the air pressure sensing member 133, and the vent H is covered by the air pressure buffer member 160. Specifically, the air pressure buffer member 160 is able to reduce the interference of turbulence on the air pressure sensing member 133, thereby further improving the accuracy of the air pressure sensing member 133. Moreover, the air pressure buffer member 160 includes, for example, a vibration absorption material 161, and the vibration absorption material 161 is compressed between the buffer member 140 and the air pressure sensing member 133. Therefore, the air pressure buffer member 160 can further reduce the vibrations to the data sensing assembly 130b in the direction Y. For example, the air pressure buffer member 160 in this embodiment may be made entirely of the vibration absorption material 161, wherein the vibration absorption material 161 may include foam. Both the vibration absorption material 161 of the air pressure buffer member 160 and the buffer member 140 may be made of foam in one embodiment, and the density of the foam used in the vibration absorption material 161 may be lower than that of the buffer member 140 to facilitate the passage of air flow. The counterweight element 150 may be provided with a groove O for accommodating the air pressure buffer member 160 in this embodiment, and the air pressure buffer member 160 may be at least partially or completely accommodated in the groove O. Incidentally, the air pressure sensing member 133 may be included in the sensing element 131b of the data sensing assembly 130b.

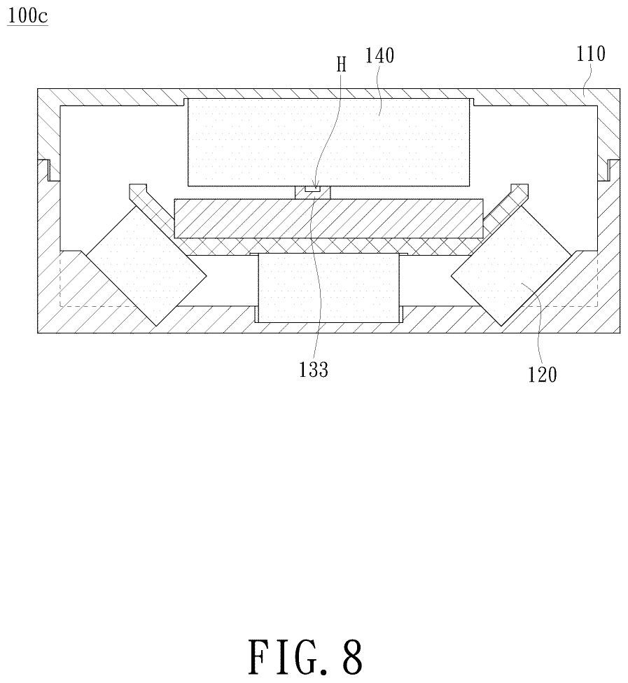

FIG. 8 is a schematic cross-sectional diagram of a vibration absorption module of a fourth embodiment of the disclosure. The structure and advantages of the vibration absorption module 100c in this embodiment are similar to those in the embodiment in FIG. 1, and only the differences are described below. It is understood that the buffer member 140 in FIG. 1 can be used as the air pressure buffer member 160 in FIG. 6. For example, referring to FIG. 8, the vent H of the air pressure sensing member 133 can be directly covered by the buffer member 140. Particularly, because the vibration absorption module 100c is not provided with the counterweight element 150 in FIG. 6, the buffer member 140 can directly contact the air pressure sensing member 133 and cover the vent H. In this case, the air pressure buffer member 160 in FIG. 6 can be omitted from the vibration absorption module 100c.

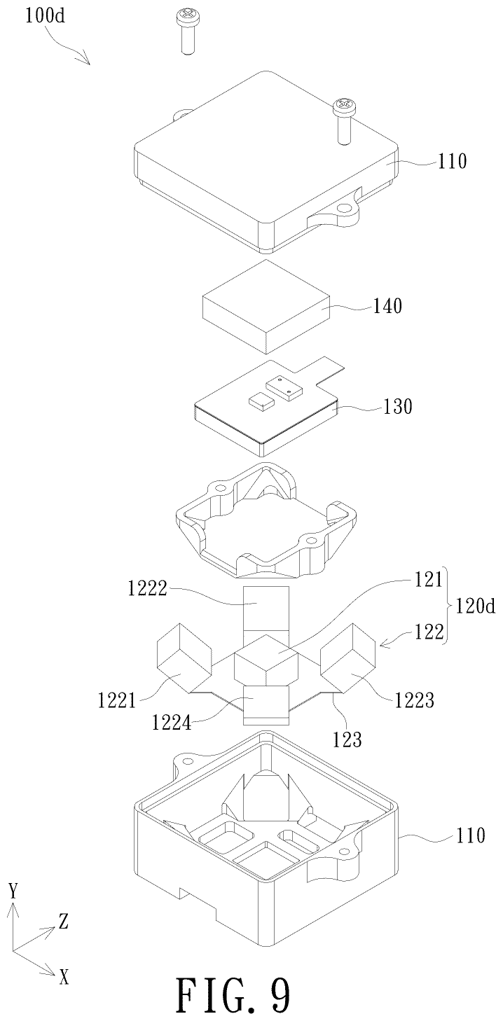

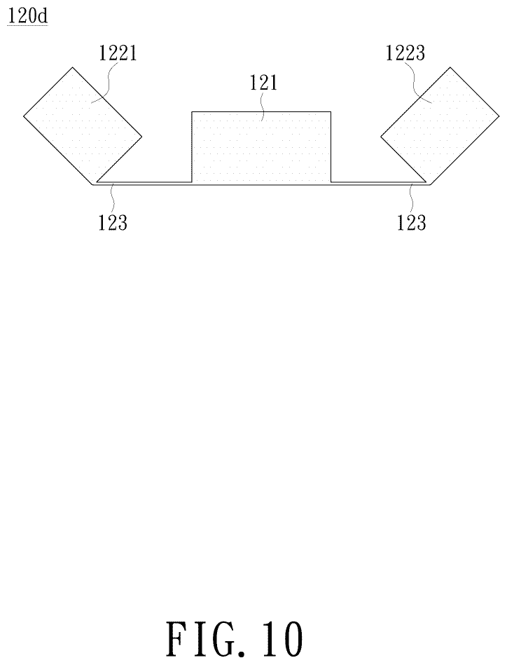

FIG. 9 is a schematic explosion diagram of a vibration absorption module of a fifth embodiment of the disclosure. FIG. 10 is a schematic cross-sectional diagram of the vibration absorption assembly in FIG. 9. The structure and advantages of the vibration absorption module 100d in this embodiment are similar to those in the embodiment in FIG. 1, and only the differences are described below. Referring to FIGS. 9 and 10, the central portion 121 and the surround portion 122 of the vibration absorption assembly 120d can be connected to each other. For example, the vibration absorption assembly 120d can further have at least one connecting section 123, and this embodiment takes one connecting section 123 as an example. The first vibration absorption member 1221, the second vibration absorption member 1222, the third vibration absorption member 1223, and the fourth vibration absorption member 1224 are respectively connected to the central portion 121 through the connecting section 123. Specifically, the central portion 121, the surround portion 122 and the connecting section 123 may be in an integrated structure manner. For example, the central portion 121, the surround portion 122, and the connecting section 123 may be cut and formed from the same piece of foam. The connecting section 123 may be plural in an embodiment, and each of the connecting sections 123 may be separated from each other; that is, a plurality of connecting sections 123 are respectively connected to the central portion 121 and the first vibration absorption member 1221, the second vibration absorption member 1222, the third vibration absorption member 1223 and the fourth vibration absorption member 1224 corresponding to the central portion 121. It can be understood that the number, shape, thickness and other features of the connecting section 123 can be determined according to the needs in practice, which are not limited by the disclosure.

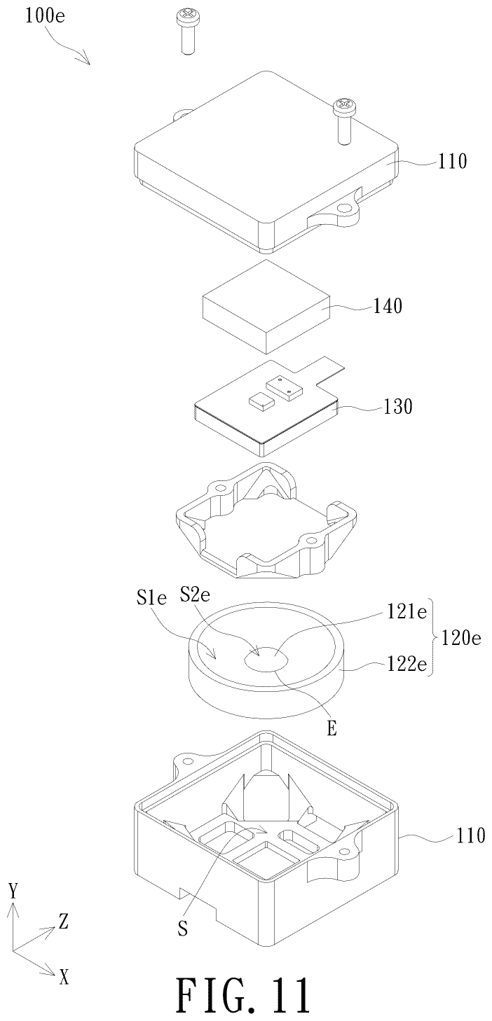

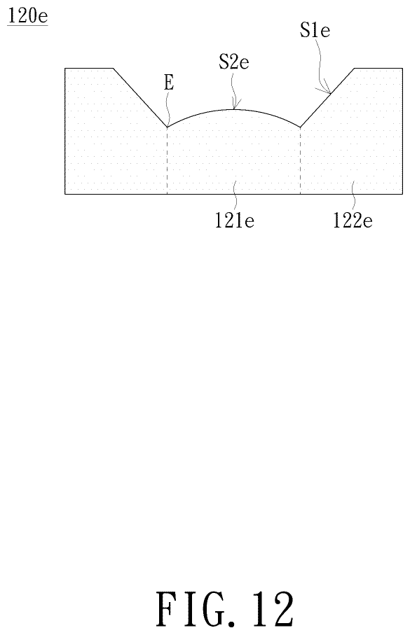

FIG. 11 is a schematic explosion diagram of a vibration absorption module of a sixth embodiment of the disclosure. FIG. 12 is a schematic cross-sectional diagram of the vibration absorption assembly in FIG. 11. The structure and advantages of the vibration absorption module 100e in this embodiment are similar to those in the embodiment in FIG. 9, and only the differences are described below. Referring to FIGS. 11 and 12, the second pressed surface S2e of the central portion 121e faces away from the surface S and has an edge E. The surround portion 122e is connected to the edge E, and the surround portion 122e continuously surrounds the second pressed surface S2e. Moreover, the central portion 121e and the surround portion 122e of the vibration absorption assembly 120e may be in an integrated manner, wherein the second pressed surface S2e of the central portion 121e may be in a circular manner, and the first pressed surface S1e of the surround portion 122e may be in an annular manner and connected to the edge E of the second pressed surface S2e. For these reasons, the vibration absorption assembly 120e further has the advantage of being easy to install through its integrated structure. Similarly, the vibration absorption assembly 120e may be formed by cutting foam, but the materials and manufacturing processes of the vibration absorption assembly 120e are not limited by the disclosure.

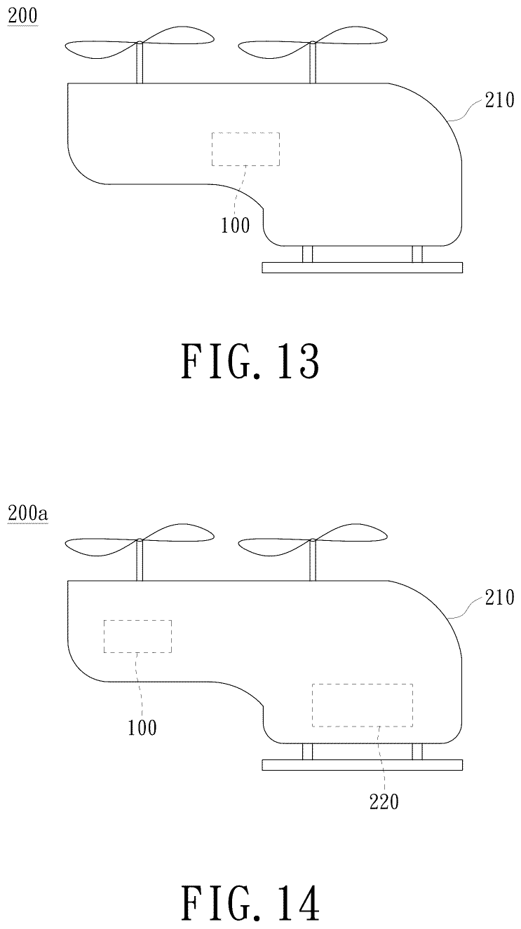

FIG. 13 is a schematic diagram of an unmanned vehicle of an embodiment of the disclosure. An unmanned vehicle 200 includes a vehicle body 210 and the vibration absorption module 100. The vibration absorption module 100 is disposed at the vehicle body 210. The vehicle body 210 includes, for example, unmanned aerial vehicles, but the vehicle body 210 may include unmanned land vehicles or unmanned water vehicles, etc. in other embodiments, which is not limited by the disclosure. The vibration absorption module 100 in this embodiment may be disposed in the vehicle body 210, and the specific location of the vibration absorption module 100 is not limited to that shown in FIG. 13.

Compared with the prior art that integrates the sensor on the printed circuit board, the unmanned vehicle 200 of this embodiment uses the vibration absorption module 100, and the data sensing assembly 130 is independent from the printed circuit board for vibrations absorption. Thus, the interference caused by the vibrations on the data sensing assembly can be effectively reduced. Also, because the vibration absorption module 100 integrates the vibration absorption assembly, the data sensing assembly 130 and the buffer member 140 in the shell assembly, the vibration absorption module 100 can be more flexibly disposed at any position of the vehicle body 210. The unmanned vehicle 200 can use the vibration absorption module 100a, 100b, 100c, 100d or 100e in other embodiments.

FIG. 14 is a schematic diagram of an unmanned vehicle of another embodiment of the disclosure. The structure and advantages of the unmanned vehicle 200a in this embodiment are similar to those in the embodiment in FIG. 13, and only the differences are described below. Referring to FIG. 14, the unmanned vehicle 200a further includes, for example, a battery 220, and the battery 220 and the vibration absorption module 100 are respectively disposed on two opposite sides of the vehicle body 210 to reduce the interference of electromagnetic waves generated by the battery 220 on the data sensing assembly. For example, the vibration absorption module 100 and the battery 220 can be respectively disposed on two opposite sides of the vehicle body 210 farthest from each other, but other embodiments are not limited thereto.

In summary, the vibration absorption module and the unmanned vehicle in the embodiments of the disclosure have at least one of the following advantages. For the vibration absorption module of the disclosure, the vibration absorption assembly uses the central portion and the surround portion, wherein the central portion is able to reduce vibrations to the data sensing assembly in a vertical direction, and the surround portion is able to reduce vibrations to the data sensing assembly in a horizontal direction and the vertical direction by the first pressed surface inclined with respect to the surface. Also, the buffer member of the vibration absorption module is able to reduce vibrations to the data sensing assembly in the vertical direction. Hence, the vibration absorption module of the disclosure can effectively reduce the vibrations to the data sensing assembly in the horizontal direction and the vertical direction. The unmanned vehicle of the disclosure uses the vibration absorption module, so the unmanned vehicle is able to effectively reduce the interference caused by the vibrations on the data sensing assembly.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A vibration absorption module, comprising:
a shell assembly, comprising a base body and a cover body, the base body having a bottom plate portion and a plurality of side wall portions, the plurality of side wall portions being connected to the bottom plate portion, and the cover body being connected to the plurality of side wall portions and opposite to the bottom plate portion;
a vibration absorption assembly, disposed between the base body and the cover body and comprising a central portion and a surround portion, the central portion being fixed to a surface of the bottom plate portion facing the cover body, the surround portion being disposed around the central portion and having a first pressed surface facing the cover body, and the first pressed surface being inclined with respect to the surface;
a data sensing assembly, disposed between the vibration absorption assembly and the cover body, the data sensing assembly being in contact with the central portion and the first pressed surface; and
a buffer member, compressed between the cover body and the data sensing assembly, the buffer member being adapted to push the data sensing assembly against the central portion and the first pressed surface.

2. The vibration absorption module according to claim 1, wherein the central portion and the surround portion are connected to each other.

3. The vibration absorption module according to claim 1, wherein the surround portion comprises a plurality of vibration absorption members, and the plurality of vibration absorption members are separated from each other and respectively separated from the central portion.

4. The vibration absorption module according to claim 3, wherein the plurality of vibration absorption members are fixed to the bottom plate portion and comprise a first vibration absorption member, a second vibration absorption member, a third vibration absorption member, and a fourth vibration absorption member, the first vibration absorption member, the second vibration absorption member, the third vibration absorption member, and the fourth vibration absorption member are separated from each other and respectively separated from the central portion, the first vibration absorption member and the second vibration absorption member are respectively disposed on two opposite sides of the central portion, and the third vibration absorption member and the fourth vibration absorption member are respectively disposed on another two opposite sides of the central portion.

5. The vibration absorption module according to claim 4, wherein the vibration absorption assembly further has at least one connecting section, the first vibration absorption member, the second vibration absorption member, the third vibration absorption member, and the fourth vibration absorption member are respectively connected to the central portion through the at least one connecting section.

6. The vibration absorption module according to claim 1, wherein the central portion has a second pressed surface, the second pressed surface faces away from the surface and has an edge, the surround portion is connected to the edge, and the surround portion continuously surrounds the second pressed surface.

7. The vibration absorption module according to claim 1, wherein an included angle between the first pressed surface and the surface is between 40 degrees and 55 degrees.

8. The vibration absorption module according to claim 1, further comprising a counterweight element, wherein the counterweight element is disposed between the buffer member and the data sensing assembly.

9. The vibration absorption module according to claim 8, wherein the data sensing assembly comprises a sensing element and a support element, the sensing element is carried by the support element, the support element is in contact with the vibration absorption assembly, and a weight of the counterweight element is greater than a weight of the sensing element.

10. The vibration absorption module according to claim 8, wherein the buffer member is compressed between the cover body and an outer surface of the counterweight element, an orthographic projection of the buffer member on the outer surface of the counterweight element has a first area, the outer surface has a second area, and the first area is less than or equal to the second area.

11. The vibration absorption module according to claim 8, further comprising an air pressure buffer member, wherein the data sensing assembly comprises an air pressure sensing member, a side of the air pressure sensing member facing the cover body has a vent, the air pressure buffer member is located between the counterweight element and the air pressure sensing member, and the vent is covered by the air pressure buffer member.

12. The vibration absorption module according to claim 11, wherein the air pressure buffer member comprises a vibration absorption material, and the vibration absorption material is compressed between the buffer member and the air pressure sensing member.

13. The vibration absorption module according to claim 1, wherein the data sensing assembly comprises a support element, the support element is disposed on the vibration absorption assembly and has a bottom surface and a positioning surface, the bottom surface faces the central portion, the positioning surface is around the bottom surface and inclined with respect to the bottom surface, the bottom surface is in contact with the central portion, and the positioning surface is in contact with the surround portion.

14. The vibration absorption module according to claim 1, wherein the data sensing assembly comprises an air pressure sensing member, a side of the air pressure sensing member facing the cover body has a vent, and the vent is covered by the buffer member.

15. An unmanned vehicle, comprising:
a vehicle body; and
a vibration absorption module, disposed at the vehicle body, the vibration absorption module comprising:
a shell assembly, comprising a base body and a cover body, the base body having a bottom plate portion and a plurality of side wall portions, the plurality of side wall portions being connected to the bottom plate portion, and the cover body being connected to the plurality of side wall portions and opposite to the bottom plate portion;
a vibration absorption assembly, disposed between the base body and the cover body and comprising a central portion and a surround portion, the central portion being fixed to a surface of the bottom plate portion facing the cover body, the surround portion being disposed around the central portion and having a first pressed surface facing the cover body, and the first pressed surface being inclined with respect to the surface;
a data sensing assembly, disposed between the vibration absorption assembly and the cover body, the data sensing assembly being in contact with the central portion and the first pressed surface; and
a buffer member, compressed between the cover body and the data sensing assembly, the buffer member being adapted to push the data sensing assembly against the central portion and the first pressed surface.

16. The unmanned vehicle according to claim 15, further comprising a battery, wherein the battery and the vibration absorption module are disposed on two opposite sides of the vehicle body.
